(19) United States
(12) Patent Application Publication
(10) Pub. No.: US 2025/0257780 A1
(43) Pub. Date: Aug. 14, 2025

(54) DAMPING VALVE DEVICE FOR A SHOCK ABSORBER OF A MOTOR VEHICLE

(71) Applicants: thyssenkrupp Bilstein GmbH, Ennepetal (DE); thyssenkrupp AG, Essen (DE)

(72) Inventor: Freddy WOENARTA, Braunschweig (DE)

(73) Assignees: thyssenkrupp Bilstein GmbH, Ennepetal (DE); thyssenkrupp AG, Essen (DE)

(21) Appl. No.: 19/046,908

(22) Filed: Feb. 6, 2025

(30) Foreign Application Priority Data
Feb. 8, 2024 (DE) 10 2024 103 604.4

(51) Int. Cl. F16F 9/18; F16F 9/34

(52) U.S. Cl. CPC F16F 9/185; F16F 9/34

(57) ABSTRACT

A vibration damper of a motor vehicle comprises an outer tube and an inner tube which is disposed so as to be coaxial with the latter, and a working piston which is disposed so as to be axially movable within the inner tube and divides the interior of the inner tube into a piston rod-proximal working chamber and a piston rod-distal working chamber, a damping valve device which is disposed in the working piston, wherein the damping valve device has a coil, an axially movable armature which is at least partially disposed within the coil, a main valve having a main piston which separates a compression main control chamber, a traction main control chamber and a pilot control chamber from one another, a pilot valve which is designed in such a manner that it is able to be passed through by a flow of hydraulic fluid in the traction phase and in the compression phase and has a pilot working chamber and a sliding tappet that is disposed in the pilot working chamber and is axially movable by means of the armature, and a connecting duct which is disposed between the pilot control chamber and the pilot working chamber and fluidically connects those to one another, wherein the compression main control chamber by way of a first flow passage, and the traction main control chamber by way of a second flow passage, are fluidically connected to the pilot control chamber.

### CROSS REFERENCE TO RELATED APPLICATION

This application is a U.S. Non-Provisional that claims priority to German Patent Application No. DE 10 2024 103 604.4, filed Feb. 8, 2024, the entire content of which is incorporated herein by reference.

### FIELD

The present disclosure relates to a damping valve device for a shock absorber for motor vehicles, wherein the damping valve device has a main valve and a pilot valve.

### BACKGROUND

Known from DE 10 2020 215 480 A1 is a vibration damper having a damping valve device, wherein the damping valve device has a pilot valve which is adjustable by way of a solenoid. An unstable behaviour of the damping valve may arise in particular in the dynamic operation of the vibration damper, when the main valve is opened and closed. Acoustic issues are additionally created during the switching procedure of the main valve. Furthermore, the damping valve devices are relatively large and therefore occupy a large installation space.

Thus a need exists to provide a damping valve device for a vibration damper, which is particularly space-saving and at the same time has a stable damping behaviour in the compression phase as well as in the traction phase, and is cost-effective in production.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper according to an exemplary embodiment in a longitudinal sectional view.

FIG. 2 shows a schematic illustration of a damping valve device of a vibration damper according to an exemplary embodiment in the compression phase, in a longitudinal sectional view.

FIG. 3 shows a schematic illustration of a damping valve device of a vibration damper according to an exemplary embodiment in the traction phase, in a longitudinal sectional view.

FIG. 4 shows a schematic illustration of a hydraulic circuit diagram of a damping valve device according to an exemplary embodiment.

FIG. 5 shows a schematic illustration of a hydraulic circuit diagram of a damping valve device according to an exemplary embodiment.

FIG. 6 shows a schematic illustration of a hydraulic circuit diagram of a damping valve device according to an exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper of a motor vehicle comprises an outer tube and an inner tube which is disposed so as to be coaxial with the latter, and a working piston which is disposed so as to be axially movable within the inner tube and divides the interior of the inner tube into a piston rod-proximal working chamber and a piston rod-distal working chamber. The vibration damper also comprises a damping valve device which is disposed in the working piston, wherein the damping valve device has a coil and an axially movable armature which is at least partially disposed within the coil. The damping valve device also comprises a main valve having a main piston which fluidically separates a compression main control chamber, a traction main control chamber and a pilot control chamber from one another. The damping valve device moreover has a pilot valve which is designed and disposed in such a manner that it is able to be passed through by a flow of hydraulic fluid in the traction phase and in the compression phase and has a pilot working chamber and a sliding tappet that is disposed in the pilot working chamber and is axially movable by means of the armature. Furthermore, the damping valve device has a connecting duct which is disposed between the pilot control chamber and the pilot working chamber and fluidically connects those to one another. The compression main control chamber by way of a first flow passage, and the traction main control chamber by way of a second flow passage, are fluidically connected to the pilot control chamber.

Providing a first and a second flow passage for connecting the main control chambers to the pilot control chamber ensures that the pilot valve is able to be passed through by a flow in the compression phase and in the traction phase of the vibration damper. The compression main control chamber and the traction main control chamber are in each case fluidically connected to the pilot control chamber.

The damping valve device is, for example, a pressure control valve which can preferably be pilot-controlled. The main valve having the main piston is preferably designed for closing and opening the damping valve device, in particular the pressure control valve. The main piston is preferably axially movable by means of the armature and/or the hydraulic pressure prevalent in the pilot control chamber.

A damping valve device designed as a pilot-controlled pressure control valve, in addition to the main valve, preferably comprises a pilot valve having a pilot working chamber and a sliding tappet which is disposed in the pilot working chamber and is axially movable by means of the armature, and a connecting duct which is disposed between the pilot control chamber and the pilot working chamber and fluidically connects those to one another.

The damping valve device is disposed in a vibration damper for a motor vehicle, for example. The vibration damper is, for example, a single-tube vibration damper or a multi-tube vibration damper, by way of example a dual-tube vibration damper. The vibration damper comprises, for example, an outer tube which forms an external face, in particular a housing, of the vibration damper. An inner tube, which is also referred to as damper tube, is disposed within the outer tube so as to be coaxial with the latter. A compensation chamber, which is preferably at least partially filled with a hydraulic fluid, is formed between the outer tube and the inner tube. For example, the compensation chamber is partially filled with a gas.

A working piston which is connected to a piston rod is preferably disposed within the inner tube in such a manner that said working piston is movable within the inner tube, wherein the inner tube is preferably designed as a guide of the working piston. A damping valve device is disposed on the working piston, for example. The working piston divides the interior of the inner tube in particular into a first, piston rod-proximal, working chamber and a second, piston rod-distal, working chamber.

The vibration damper preferably has a closure pack which fluidically seals the interior of the outer tube on the piston rod-proximal side. The interior of the outer tube at the piston rod-distal end, opposite the closure pack, is preferably fluidically sealed by means of a base piece. A base valve, which is attached to the piston rod-distal end of the inner tube, is in particular disposed on the base piece.

The damping valve device comprises a preferably cylindrical damping valve housing which has a substantially tubular tube part and a housing upper part which is attached to the tube part or is formed so as to be integral to the latter. By way of example, the tube part has a connecting region which has one or a plurality of connection contacts for an electrical current supply of the damping valve device. The connection contacts for an electrical current supply are preferably connected to a drive unit.

The damping valve device preferably has a drive which is designed as a solenoid, in particular a coil having a plurality of windings made of a current-conducting wire. The coil is preferably disposed within a housing of the damping valve device and comprises, for example, a coil carrier on which the windings of the coil are wound. The coil preferably at least partially or completely encloses an armature space which extends centrally in the axial direction. An armature is preferably mounted so as to be axially movable within the armature space. The armature is preferably attached so as to be able to slide in the axial direction within the armature space and comprises, for example, a central armature rod that by way of example is of a tubular design and extends centrally in the axial direction through the armature space. The armature space is preferably delimited by an at least partially hollow-cylindrical pole tube, which preferably serves as a guide for the armature.

The damping valve device preferably comprises a main valve and a pilot valve. The pilot valve is preferably disposed in the flow direction behind the main valve, both in the compression phase as well as in the traction phase of the vibration damper. In particular, the damping valve device is able to be passed through by a flow of hydraulic fluid in both directions. The damping valve device disposed in the working piston preferably has exactly one main valve and/or exactly one pilot valve. A seal, in particular a sealing ring, which seals the working piston in a fluid-tight manner in relation to the damper tube, is attached to the working piston, for example. The working piston preferably comprises a first fluid passage to the piston rod-proximal working chamber. The damping valve device is preferably fluidically connected to the piston rod-proximal working chamber by way of the first fluid passage. By way of example, in a movement of the piston rod in the traction direction, the first fluid passage is designed as a fluid inlet to allow hydraulic fluid to enter the damping valve device, and in a movement of the piston rod in the compression direction, designed as a fluid outlet to allow hydraulic fluid to exit the damping valve device. The working piston preferably has a second fluid passage to the piston rod-distal working chamber, by way of which the damping valve device is preferably fluidically connected to the second, piston rod-distal, working chamber. In a movement of the piston rod in the compression direction, the second fluid passage is preferably designed as a fluid inlet to allow hydraulic fluid to enter an optional comfort valve and/or the main valve, and in a movement of the piston rod in the traction direction, designed as a fluid outlet to allow hydraulic fluid to exit the optional comfort valve and/or the main valve.

The main valve preferably comprises a main piston which is disposed so as to be axially movable within a main working chamber. The main valve optionally comprises a housing part which at least partially delimits the main working chamber and forms an axial guide for the main piston. The main piston is preferably disposed in such a manner that it fluidically separates a compression main control chamber, a traction main control chamber and a pilot control chamber from one another. The main control chamber is understood to be the hydraulic space that is preferably directly contiguous to the main piston and preferably impinges the latter with a hydraulic force acting in the opening direction of the main valve. A main valve which is able to be passed through by a flow in the traction phase and in the compression phase preferably has a compression main control chamber which is designed and disposed in such a manner that the latter in the compression phase impinges the main piston with a hydraulic force acting in the opening direction, and has a traction main control chamber which is designed and disposed in such a manner that the latter in the traction phase impinges the main piston with a hydraulic force acting in the opening direction. The main valve preferably has a main valve seat, wherein, in an opened position of the main valve, a main flow duct is formed between the main piston and the main valve seat. The traction main control chamber and the compression main control chamber are preferably fluidically connected to one another by way of the main flow duct. The hydraulic pressure of the piston rod-distal working chamber is preferably applied in the compression main control chamber, wherein the hydraulic pressure of the piston rod-proximal working chamber is preferably applied in the traction main control chamber.

The main valve seat is preferably formed on a directing element which is attached in a positionally fixed manner within the damping device, wherein the main piston is movable relative to said directing element. A spring assembly, which in the closed position of the main valve lies against the main valve seat of the directing element, is in particular attached to the main piston. The spring assembly preferably comprises a plurality of, in particular two, spring discs which are coaxially disposed in relation to one another and preferable lie against one another. The spring disc of the spring assembly that points in the direction of the compression main control chamber preferably lies against the main valve seat and has in particular a bypass opening.

The pilot control chamber is understood to mean the hydraulic space which is preferably directly contiguous to the main piston and preferably impinges the latter with a hydraulic force acting in the closing direction of the main valve. The pilot control chamber is preferably disposed on the main piston so as to be opposite the traction main control chamber and the compression main control chamber. For example, the main piston is designed in such a manner that the end face of the main piston that faces the compression main control chamber or the traction main control chamber and is impinged with the hydraulic pressure of the compression main control chamber or the traction main control chamber is larger than the end face of the main piston that faces the pilot control chamber and is impinged with the hydraulic pressure of the pilot control chamber.

During operation of the damping valve device and during a movement of the piston rod in the compression direction, the hydraulic fluid preferably flows out of the piston rod-distal working chamber through the second fluid passage into the optional comfort valve, into the compression main control chamber, whereby the pressure in the compression main control chamber impinges the main piston with an opening force and is moved axially upward. In the process, the main piston is lifted from the main valve seat and the hydraulic fluid flows through the main flow duct to the traction main control chamber, in particular the second fluid passage, and subsequently into the piston rod-proximal working chamber. At the same time, in particular hydraulically parallel therewith, a partial flow of the hydraulic fluid flows through the pressure flow passage in the main piston to the pilot control chamber and impinges the main position with a closing force in the direction of the main valve seat. The closing force determines the opening width of the main valve, in particular the cross section of the main flow duct, which determines the damping force of the damping valve device. The pressure in the pilot control chamber is preferably set by the pilot valve, wherein the hydraulic fluid flows from the pilot control chamber through the connecting duct into the pilot working chamber which is released by the sliding tappet. The opening width, in particular the outflow cross section, of the connecting duct is preferably dependent on the axial position of the sliding tappet, which is set by means of the solenoid. In the closed position of the pilot valve, the sliding tappet preferably closes the connecting duct completely in such a way that the hydraulic pressure in the pilot control chamber increases to a maximum value and the main valve is closed in that the main piston is pressed onto the main valve seat. In an opened position of the pilot valve, the connecting duct is at least partially released by the sliding tappet.

According to a first embodiment, one flow throttle is in each case disposed in the first flow passage and the second flow passage. The first flow passage preferably extends at least partially or completely through the main piston, and preferably fluidically connects the compression main control chamber to the pilot control chamber. In particular, the first flow passage extends centrally and in the axial direction through the main piston. The second flow passage is disposed, for example, in a positionally fixed housing part of the damping valve device and fluidically connects the traction main control chamber to the pilot control chamber. The main piston has, for example, a first piston region, which is adjoined in the axial direction by a second piston region with a smaller diameter than the first piston region. The first flow passage preferably extends exclusively through the first piston region of the main piston, in particular centrally and in the axial direction through the latter into the pilot control chamber. A flow throttle in each flow passage permits a separate setting of the flow throttle in the traction phase and the compression phase.

According to a further embodiment, one check valve is in each case disposed on the first flow passage and the second flow passage so that hydraulic fluid is in each case able to flow through the first and the second flow passage exclusively in one direction. The first flow passage preferably has a check valve which is disposed in such a manner that a hydraulic flow is enabled from the traction main control chamber into the pilot control chamber and prevented in the opposite direction. The second flow passage preferably has a check valve which is disposed in such a manner that a hydraulic flow is enabled from the compression main control chamber into the pilot control chamber and prevented in the opposite direction. A check valve in each of the flow passages enables rectification of the hydraulic flows in the traction phase and the compression phase into the pilot control chamber so that the same pilot control chamber and the adjoining pilot valve can be used both in the traction phase and in the compression phase.

According to a further embodiment, the first flow passage and the second flow passage are in particular disposed completely separately from one another. As a result, directing separate flows is achieved in the traction phase and in the compression phase.

According to a further embodiment, the connecting duct for fluidically connecting the pilot control chamber to the pilot working chamber is formed in the main piston. The connecting duct extends in particular centrally and in the axial direction through the main piston, from the pilot control chamber into a pilot working chamber. The connecting duct preferably forms the fluid inlet into the pilot valve. The pilot working chamber preferably fluidically adjoins the connecting duct directly. The connecting duct in the main piston preferably ensures a simple direct fluidic connection between the pilot control chamber and the pilot working chamber, wherein the hydraulic fluid flows axially in the direction of the armature through the pilot working chamber.

According to a further embodiment, the sliding tappet in the closed position of the pilot valve lies against the main piston in such a manner that said sliding tappet fluidically closes the connecting duct. The main piston preferably forms a pilot valve seat, the sliding tappet in the closed position of the pilot valve lying against said pilot valve seat. The sliding tappet lying against the main piston enables a sequence control, wherein the sliding tappet impinges the main piston directly with a closing force which is applied to the sliding tappet by way of the armature rod. As a result, a high operational reliability is achieved. The pilot valve preferably comprises a sliding tappet which is disposed so as to be axially movable within the pilot working chamber. The sliding tappet by way of its end that faces away from the main valve preferably lies against the armature in such a way that the movement of the armature and of the sliding tappet are mechanically coupled.

According to a further embodiment, the pilot valve has a pilot spring which is disposed in such a manner that the latter impinges the sliding tappet with an axial force acting in the direction of the armature, in particular in the opening direction of the pilot valve. The pilot spring preferably enables a fail-safe protection in the event that the coil is unintentionally de-energized. The pilot spring preferably lies against the sliding tappet and the main piston. In particular, the pilot spring is designed as a spiral spring and lies against the main piston within a hollow-cylindrical region of the latter. By way of example, the pilot spring is supported on an annular step of the sliding tappet that points in the direction of the piston rod-distal working chamber.

According to a further embodiment, the damping valve device has a spring element which is attached to the main piston in such a manner that said spring element impinges the main piston with a spring force acting in the closing direction of the main valve. The spring element is preferably attached to the side of the main piston that faces away from the main valve seat. In particular, the spring element is disposed in such a manner that it impinges the main piston with a spring force acting in the direction of the valve seat. The spring element is designed, for example, as a spiral spring which bears against the internal face of a hollow-cylindrical region of the main piston, and is supported on an end face of the main piston that points in the direction of the drive region. The spring element by way of one end preferably lies against a positionally fixed housing part of the damping valve device.

According to a further embodiment, the main piston has a closing face which is contiguous to the pilot control chamber and is disposed in such a manner that the hydraulic pressure prevalent in the pilot control chamber impinges the closing face of the main piston with an axial force acting in the closing direction of the main valve, and wherein the closing face is formed as a step in the main piston. The main piston is preferably of stepped design and in particular has a first piston region which points in the direction of the piston rod-distal working region, and which by way of its external diameter preferably lies in a fluid-tight manner against a positionally fixed housing part of the damping valve device. The first piston region is preferably designed to be substantially cylindrical. The first piston region is adjoined in particular by a second cylindrical piston region which is disposed so as to be coaxial with the first piston region and preferably has a smaller diameter than the first piston region. Formed on the first piston region is preferably an annular, preferably circular disc-shaped, end face that points in the direction of the drive region. The end face is preferably designed as a closing face, in particular as a first closing face, of the main piston, and is in particular contiguous to the pilot control chamber, so that the hydraulic pressure prevalent in the pilot control chamber impinges the main piston, in particular the closing face of the main piston, with an axial force acting in the closing direction of the main valve.

Formed on the second piston region is preferably an annular end face that points in the direction of the drive region and is formed in particular as a second closing face of the main piston, in addition to the closing face described above. The second closing face is contiguous to the pilot working chamber, so that the hydraulic pressure prevalent in the pilot working chamber impinges the second closing face of the main piston with an axial force acting in the closing direction of the main valve. The entire closing face of the main piston therefore preferably comprises the first and the second closing face. In particular, the size and/or the position of the closing face of the main piston is the same for a tensile or compressive load of the vibration damper. The sliding tappet is preferably disposed and designed in such a manner that hydraulic fluid can flow through the connecting duct exclusively in one flow direction.

According to a further embodiment, the main piston has a traction opening face A_{Z} which is directly contiguous to the traction main control chamber and has a compression opening face A_{D} which is directly contiguous to the compression main control chamber, and wherein the ratio A_{Z}/A_{D} between the traction opening face A_{Z} and the compression opening face A_{D} is 1:1 to 5:1, in particular 2:1 to 4:1, preferably 3:1.

According to a further embodiment, the damping valve device has a first pilot outflow duct for fluidically connecting the pilot working chamber to the traction main control chamber, and a second pilot outflow duct for fluidically connecting the pilot working chamber to the compression main control chamber. As a result, a separate outflow of the hydraulic fluid from the pilot working chamber in the traction phase and the compression phase is made possible.

The first pilot outflow duct is preferably formed in a positionally fixed housing part of the vibration damper, and preferably extends from the pilot working chamber into the traction main control chamber. The first pilot outflow duct preferably has a check valve which is disposed in such a manner that a hydraulic flow is enabled from the pilot working chamber into the first fluid passage, in particular the piston rod-proximal working chamber and is prevented in the opposite direction. The first pilot outflow duct is disposed, for example, above the sliding tappet, in particular in the traction direction relative to the sliding tappet.

The second pilot outflow duct is preferably designed for fluidically connecting the pilot working chamber to the piston rod-distal working chamber. The second pilot outflow duct is formed in particular in the main piston and preferably extends axially through the latter, in particular through the first and the second piston region. The second pilot outflow duct preferably extends from the pilot working chamber into the compression main control chamber. The second pilot outflow duct preferably has a check valve which is disposed in such a manner that a hydraulic flow is enabled from the pilot working chamber into the piston rod-distal working chamber and is prevented in the opposite direction.

According to a further embodiment, the damping valve device comprises a comfort valve which in the compression phase and in the traction phase is able to be passed through by a flow of hydraulic fluid. In particular, the comfort valve comprises at least one comfort spring disc pack, which for example comprises at least one or a plurality of spring discs that lies/lie against a comfort valve seat. The comfort valve preferably has two spring disc packs, wherein one is designed for damping the hydraulic fluid during a movement of the piston rod in the traction direction, and the other spring disc pack is designed for damping the hydraulic fluid during a movement of the piston rod in the compression direction. The comfort valve is preferably fluidically connected directly to the piston rod-distal working chamber. The comfort valve preferably forms the end of the working piston that points in the direction of the base valve.

According to a further embodiment, the damping valve device comprises a bypass duct which is disposed in such a way that it fluidically connects the compression main control chamber and the traction main control chamber to one another. The bypass duct is preferably formed hydraulically in parallel with the main flow duct, as a bypass of the main valve. The bypass duct extends in particular from the compression main control chamber to the traction main control chamber and fluidically connects those to one another.

According to a further embodiment, a check valve is disposed on the bypass duct in such a manner that the bypass duct is able to be passed through by a flow of hydraulic fluid exclusively in one direction. The bypass duct preferably has a check valve which is disposed and designed in such a manner that it allows a hydraulic flow from the compression main control chamber into the traction main control chamber and prevents it in the opposite direction. In particular, a throttle element is disposed so as to be hydraulically connected in series with the check valve in the bypass duct. The damping valve device additionally has, for example, a further bypass duct which is preferably connected hydraulically in parallel with the bypass duct and in particular has a flow throttle. The further bypass duct is preferably able to be passed through by a flow of hydraulic fluid in the traction phase and the compression phase of the vibration damper.

According to a further embodiment, the sliding tappet has an opening face which in the closed position of the pilot valve lies at least partially against the main piston, and wherein the opening face has a clearance. The opening face is preferably formed on the end face of the sliding tappet that faces the connecting duct and is preferably disposed in such a manner that, in the closed position of the pilot valve, it completely closes the connecting duct. The opening face preferably has an, in particular central, clearance that points in the axial direction and which, by way of example, is conical. The clearance is designed to be, for example, cylindrical with a round, circular or angular cross section. The clearance preferably serves to increase the opening face and thus to set the opening pressure of the pilot valve.

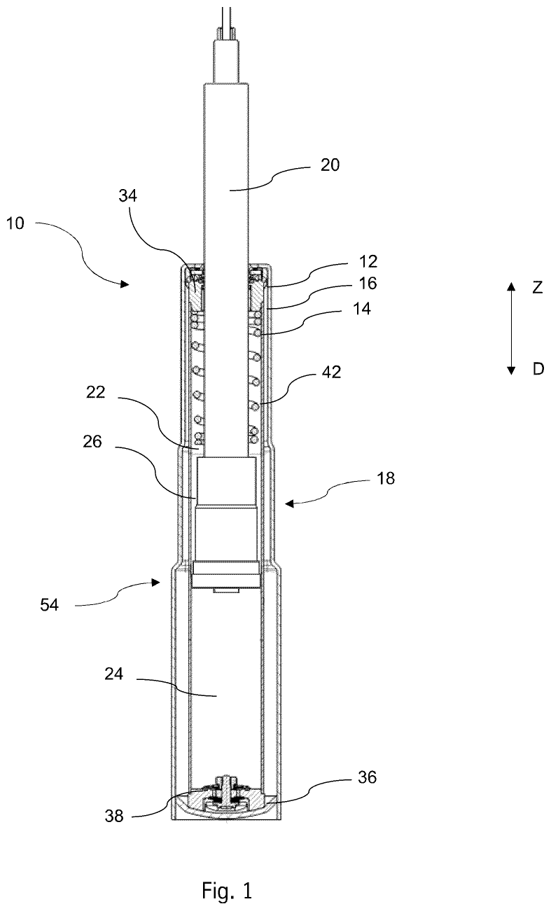

FIG. 1 shows a vibration damper 10, wherein the vibration damper 10 is a multi-tube vibration damper, by way of example a dual-tube vibration damper. The vibration damper 10 has an outer tube 12 which forms an external face in particular a housing, of the vibration damper 10. An inner tube 14, which can also be referred to as a damper tube is disposed within the outer tube 12 so as to be coaxial with the latter. Formed between the outer tube 12 and the inner tube 14 is a compensation chamber 16 which is preferably at least partially filled with a hydraulic fluid. For example, the compensation chamber 16 is partially filled with a gas.

A working piston 18, which is connected to a piston rod 20, is disposed within the inner tube 14 in such a manner that said working piston is movable within the inner tube 14, wherein the inner tube is preferably designed as a guide of the working piston 18. The working piston 18 has a damping valve device 54. The working piston 18 divides the interior of the inner tube 14 into a first working chamber 22, which is disposed proximal to the piston rod, and a second working chamber 24, which is disposed so as to be distal from the piston rod.

The interior of the outer tube 12 is fluidically sealed off on the piston rod side by means of a closure pack 34. Opposite from the closure pack 34, at the piston rod-distal end, the interior of the outer tube 12 is fluidically sealed off by means of a base piece 36. By way of example, a base valve 38, which is in particular attached to the piston rod-distal end of the inner tube 14, is disposed on the base piece 36. The base valve 38 is, for example, a check valve which is able to be passed through by a flow in both directions or only one direction. The second working chamber 24 is preferably fluidically connected to the compensation chamber 16 by way of the base valve 38. The piston rod-proximal end of the inner tube 14 and of the outer tube 12 is preferably fastened to the closure pack 34.

By way of example, the piston rod 20 has an optional traction stop, which is impinged with a spring force by way of a spring element 42 during a movement in the traction direction Z.

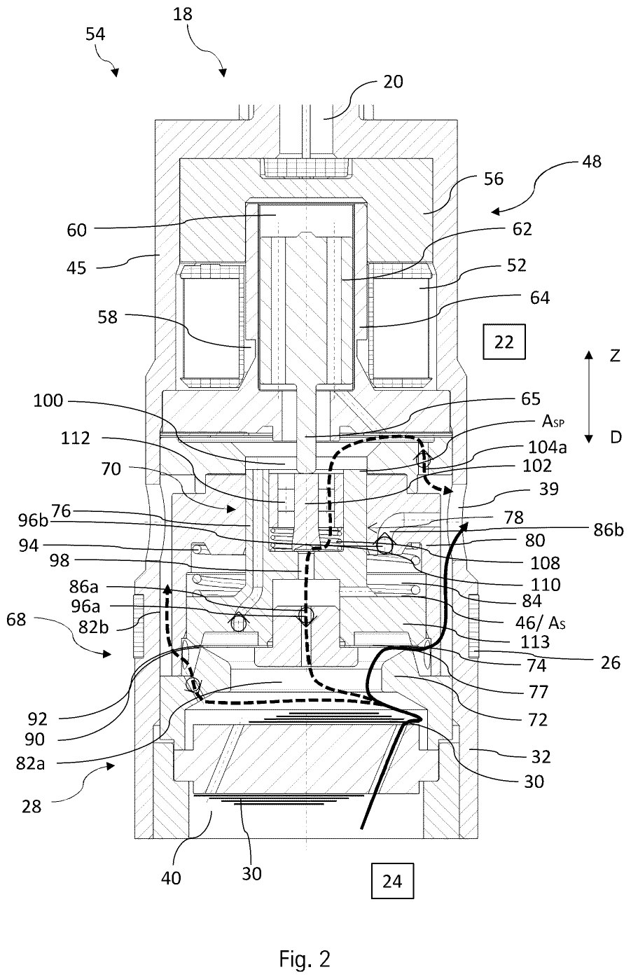

FIG. 2 shows an exemplary damping valve device 54 which is preferably disposed in the working piston 18 of the vibration damper 10. The damping valve device 54 is designed, by way of example, as a pilot-controlled pressure control valve and comprises a preferably cylindrical damping valve housing which has, by way of example, a substantially tubular tube part 45 and has a housing upper part 44, the latter being designed in one piece with the tube part 45, for example. The piston rod 20 is preferably attached to the housing upper part 44. The housing upper part 44 has, for example, a connection region (not illustrated) which has one or a plurality of connection contacts for an electrical power supply of the damping valve device 54. The connection contacts for an electrical current supply are preferably connected to a drive unit.

By way of example, the damping valve device 54 has a drive region 48 and a valve region 50. By way of example, the drive region 48 is disposed in the upper region of the damping valve device 54 that faces the piston rod 20, and preferably substantially above the valve region 50, in particular in the traction direction Z. The drive region 48 preferably comprises a drive in the form of a solenoid. The solenoid comprises a coil 52 having a plurality of windings made of a current-conducting wire. The coil 52 is preferably disposed within the tube part 45 and so as to be concentric with the latter. By way of example, the coil 52 lies against the inner wall of the tube part 45. By way of example, a cover section 56 is disposed axially between the coil 52 and the housing upper part 44. The coil 52 preferably lies against the cover portion 56 and is in particular fastened thereto. The cover portion 56 is formed for example from a metal, in particular a magnetic material, preferably a material having a low magnetic resistance. The coil 52 comprises, for example, a coil carrier on which the windings of the coil are wound. The coil 52 encloses at least partially or completely an armature space 60 which extends centrally in the axial direction. An armature 62 is mounted so as to be axially movable within the armature space 60. The armature 62 is preferably of a cylindrical design and has a diameter which is slightly smaller than the diameter of the armature space 60, so that the armature 62 is preferably mounted so as to be able to slide in the axial direction. By way of example, the armature 62 comprises a central armature rod 65 which, by way of example, has a round cross section and extends centrally in the axial direction through the armature space 60. The armature space 60 is preferably delimited by an at least partially hollow-cylindrical pole tube 64. The pole tube 64 preferably has a base and is designed to be open in particular in the direction of the valve region 50. The pole tube 64 is preferably made of a magnetizable or magnetic material and has, for example, a magnetic separation 58.

The coil 52 is preferably designed and disposed in such a manner that, when impinged with a current, it forms a magnetic field which has magnetic field lines which preferably run substantially in the axial direction in the armature space 60. The armature 62 is preferably made of a magnetizable or magnetic material and is movable in the axial direction, corresponding to the magnetic field formed by means of the coil 52.

The hollow-cylindrical region of the pole tube 64 is adjoined in the axial direction and coaxially therewith by a pole tube element, conjointly forming the pole tube 64, wherein the pole tube 64 is formed in particular in multiple parts, integrally or in one part. The pole tube 64 has an upper tubular region with an in particular constant internal diameter, which is preferably formed as a hollow cylinder and extends, for example, from the cover portion 56 in the axial direction as far as beyond the armature 62. The upper hollow-cylindrical region is adjoined in the axial direction by a lower region with an enlarged diameter, wherein the external face of the pole tube 64 preferably extends as far as the tube part 45 and at least partially lies against the latter and is sealed off in a fluid-tight manner in relation to the tube part 45 by means of, for example, a sealing element. The tube part 45 encloses at least partially or completely a valve region 50 in the axial and in the circumferential direction, said valve region being explained in more detail in one of the following paragraphs.

By way of example, the valve region 50 comprises a main valve 68 and a pilot valve 70. Preferably, the damping valve device 54 disposed in the working piston 18 has exactly one main valve 68 and/or exactly one pilot valve 70. Preferably, the main valve 68 and/or the pilot valve 70 are/is able to be passed through by a flow of hydraulic fluid during a movement of the piston rod 20 in the traction direction Z and in the compression direction D. Attached to the working piston 18 is preferably a seal 26, for example a sealing ring, which seals the working piston 18 in a fluid-tight manner in relation to the damper tube 14. The seal 26 preferably lies in a fluid-tight manner against the external face of the working piston 18 and against the internal face of the damper tube 14. Furthermore, the damping valve device 54 optionally has a comfort valve 28. The comfort valve 28 is preferably designed in such a way that it is able to be passed through by a flow of hydraulic fluid both in the compression direction D and in the traction direction Z. In particular, the comfort valve comprises at least one comfort spring disc pack, which for example comprises at least one or a plurality of spring discs that lies/lie against a comfort valve seat. The comfort valve 28 preferably has two spring disc packs, wherein one is designed for damping the hydraulic fluid during a movement of the piston rod 20 in the traction direction Z and the other spring disc pack is designed for damping the hydraulic fluid during a movement of the piston rod 20 in the compression direction D. The comfort valve 28 is preferably fluidically connected directly to the piston rod-distal working chamber 24. Preferably, the comfort valve 28 is disposed in the piston rod-distal working chamber 24 and in particular forms the end of the working piston 18 that points in the direction of the base valve 36. By way of example, the comfort valve 28 comprises a comfort valve housing 32 which is preferably formed separately from the tube part 45 and fixedly connected thereto or formed integrally with the tube part 45. By way of example, the comfort valve housing 32 has a larger external diameter than the tube part 45. Preferably, the seal 26 is attached to the comfort valve housing 42 and connected thereto in a fluid-tight manner. The comfort valve housing 32 surrounds the comfort spring disc packs 30 preferably axially and circumferentially.

The working piston 18 comprises a first fluid passage 39 to the first working chamber 22, wherein the first fluid passage 39 is formed by way of example in the tube part 45, by way of example as a circular opening. The damping valve device 54 is preferably fluidically connected to the first, piston rod-proximal, working chamber 22 by way of the first fluid passage 39. By way of example, in a movement of the piston rod 20 in the traction direction Z, the first fluid passage 39 is formed as a fluid inlet for admitting hydraulic fluid into the damping valve device 54 and, in a movement of the piston rod in the compression direction D as a fluid outlet for discharging hydraulic fluid from the damping valve device 54.

The working piston 18, in particular the comfort valve 28, preferably has a second fluid passage 40 to the second working chamber 24, via which the damping valve device 54 is preferably fluidically connected to the second, piston rod-distal, working chamber 24. By way of example, the second fluid passage 40 in a movement of the piston rod 20 in the compression direction D is formed as a fluid inlet for admitting hydraulic fluid into the comfort valve 28 and the main valve 68, and in a movement of the piston rod in the traction direction Z as a fluid outlet for discharging hydraulic fluid from the comfort valve 28 and the main valve 68.

During operation of the damping valve device 54, in a piston rod movement in the traction direction Z, the hydraulic fluid preferably flows from the first fluid passage 39 into the main valve 68 and into the pilot valve 70, and subsequently optionally through the comfort valve 28 and to the second fluid passage 40. The main valve 68 comprises a main piston 76 which is disposed so as to be axially movable within a main working chamber 78. By way of example, the main valve 68 also comprises a housing part 80 which at least partially delimits the main working chamber 78 and forms an axial guide for the main piston 76. The housing part 80 is disposed, for example, within the tube part 45 and so as to be coaxial with the latter. A gap, in particular an annular space, is preferably formed between the housing part 80 and the tube part 45. The main piston 76 is preferably disposed within the housing part 80 and so as to be concentric with the latter. The main piston 76 preferably divides the main working chamber 78 into a compression main control chamber 82a, a traction main control chamber 82b and a pilot control chamber 84. The main piston 76 has in particular a first flow passage 86a, which extends through the main piston 76 and forms a fluidic connection between the compression main control chamber 82a and the pilot control chamber 84. By way of example, the first flow passage 86a extends centrally and in the axial direction through the main piston 76. By way of example, the housing part 80 has a second flow passage 86b which forms a fluidic connection between the traction main control chamber 82b and the pilot control chamber 84. By way of example, the second flow passage 86b is disposed at the same height as the first fluid passage 39. The first and the second flow passage 86a,b preferably each have a respective flow throttle 96a,b, in particular a cross-sectional constriction.

The compression main control chamber 82a is formed by way of example between the comfort valve 28 and the main piston 76. The traction main control chamber 82b is preferably formed as the gap described above, in particular the annular space, between the housing part 80 and the tube part 45. The hydraulic pressure of the second, piston rod-distal, working chamber 24 is preferably prevalent in the compression main control chamber 82a, wherein the pressure of the first, piston rod-proximal, working chamber 22 is preferably prevalent in the traction main control chamber 82b.

A guide element 72 is preferably disposed in a positionally fixed manner in the damping valve device 54 between the main valve 68 and the comfort valve 28. By way of example, the guide element 72 is of tubular design and serves for directing hydraulic fluid from the comfort valve 28 to the main valve 68. By way of example, the guide element 72 forms at least partially the compression main control chamber 82a. The guide element 72 is preferably connected directly or indirectly to the tube part 45 and is disposed in a positionally fixed manner relative to the latter. A main valve seat 90 is preferably formed on the guide element 72. Attached to the main piston 76 is, for example, a spring assembly 77 which in the closed position of the main valve 68 lies against the main valve seat 90 of the guide element 72. The spring assembly 77 preferably comprises a plurality of, in particular two, spring discs which are disposed coaxially with respect to one another and preferably bear against one another. The spring disc of the spring assembly 77 that points in the direction of the compression main control chamber 82a preferably lies against the main valve seat 90 and has, in particular, a bypass opening 74.

In the opened position of the main valve 68, in which the main piston 76 is moved away from the main valve seat 90 in the axial direction, the main piston 76 and the spring assembly 77 are lifted from the main valve seat 90 in such a way that a main flow duct 92 is formed between the main piston 76 and the main valve seat 90. The main flow duct 92 forms a fluidic connection between the first and the second working chamber 22, 24. In particular, the main flow duct 92 forms a fluidic connection between the compression main control chamber 82a and the traction main control chamber 82b. Optionally, the damping valve device 54 has a bypass duct 88 which is preferably formed hydraulically in parallel with the main flow duct 92, as a bypass of the main valve 68. By way of example, the bypass duct 88 extends from the compression main control chamber 82a to the traction main control chamber 82b and fluidically connects those to one another. The bypass duct 88 preferably has a check valve which is disposed and designed in such a manner that it allows a hydraulic flow from the pressure main control chamber 82a into the traction main control chamber 82b and prevents it in the opposite direction.

The main piston 76 is preferably of a stepped design and has, by way of example, a first piston region 113 that points in the direction of the piston rod-distal working region 24 and by way of its outer diameter lies against the housing part 80 in a fluid-tight manner. By way of example, the first piston region 113 is substantially cylindrical. The first piston region 113 is adjoined by a second cylindrical piston region 114 which is disposed so as to be coaxial with the first piston region 113 and has a smaller diameter than the first piston region 113. An annular end face 46 that points in the direction of the drive region 48 is preferably formed on the main piston 76, in particular on the first piston region 113. The end face 46 serves as a closing face A_{S} of the main piston 76 and adjoins the pilot control chamber 84, such that the hydraulic pressure prevailing in the pilot control chamber 84 impinges the main piston 76, in particular the closing face 46 of the main piston 76, with an axial force acting in the closing direction of the main valve. The pilot control chamber 84 is preferably delimited by the closing face 46, the housing part 80 and the main piston 76, in particular the second region of the main piston 76. The first flow passage 86a for connecting the compression main control chamber 82a preferably extends exclusively through the first region of the main piston 76, in particular centrally and in the axial direction through said main piston into the pilot control chamber 84. The first flow passage 86a preferably has a check valve which is disposed in such a manner that a hydraulic flow is enabled from the compression main control chamber 82a into the pilot control chamber 84 and is prevented in the opposite direction. The second flow passage 86b preferably likewise has a check valve which is disposed in such a manner that a hydraulic flow is enabled from the traction main control chamber 82b into the pilot control chamber 84 and is prevented in the opposite direction.

An annular end face A_{SP}, that points in the direction of the drive region 48 is preferably formed on the main piston 76, in particular on the second piston region 114. The end face A_{SP} serves, in addition to the closing face A_{S}, as a further, in particular second, closing face A_{SP} of the main piston 76 and is contiguous to the pilot working chamber 100 in such a way that the hydraulic pressure prevalent in the pilot working chamber 100 impinges the main piston 76, in particular the closing face A_{SP} of the main piston 76, with an axial force acting in the closing direction of the main valve 68.

Attached to that side of the main piston 76 that faces away from the main valve seat 90 is a spring element 94 which is disposed in such a manner that it impinges the main piston 76 with a spring force acting in the direction of the valve seat 90. The spring element 94 is, for example, a spiral spring which lies against the internal face of a hollow-cylindrical region of the housing part 80 and by way of one end is supported on the end face 46, in particular the closing face A_{S}, of the main piston 76, said end face pointing in the direction of the drive region 48. The spring element 94 by way of the other end is preferably supported on the housing part 80. By way of example, the housing part has a groove in which the spring element 94 is disposed.

A connecting duct 98 which in particular extends centrally and in the axial direction from the pilot control chamber 84 through the main piston 76 into a pilot working chamber 100 is preferably formed in said main piston. Preferably, the connecting duct 98 forms the fluid inlet into the pilot valve 70. That region of the main piston 76 that points in the direction of the drive region 48 is, by way of example, designed to be hollow-cylindrical, wherein the interior of the hollow-cylindrical region preferably forms at least partially the pilot working chamber 100. Preferably, the pilot working chamber 100 fluidically adjoins directly the connecting duct 98.

By way of example, the pilot valve 70 comprises a sliding tappet 102 which is disposed so as to be axially movable within the pilot working chamber 100. The sliding tappet 102 by way of its end that faces away from the main valve 68 preferably lies against the armature 62, in particular the armature rod 65, so that the movement of the armature 62 and of the sliding tappet 102 is coupled at least during the movement of the armature 62 in the direction of the sliding tappet 102. In a closed position of the pilot valve 70, the sliding tappet 102 preferably lies against the main piston 76 in such a way that the connecting duct 98 is completely closed by the sliding tappet 102. In an opened position of the pilot valve 70, the sliding tappet 102 is lifted from the main piston 76 in such a way that the connecting duct 98 is opened by the sliding tappet 102 and a fluid flow takes place between the pilot control chamber 84 of the main valve 68 and the pilot working chamber 100. The sliding tappet 102 is preferably attached so as to be axially movable relative to the main piston 76. In particular, the sliding tappet 102 is guided axially by the main piston 76 and preferably lies, in particular in a fluid-tight manner, against the inner wall of the hollow-cylindrical region of the main piston 76.

By way of example, the sliding tappet 102 has a T-shaped longitudinal section, wherein the sliding tappet 102 has a first region that faces the connecting duct 98 and has a cross section which is larger than the cross section of the connecting duct 98, and a second region that faces the armature 62 and has a larger cross section than the first region. The second region preferably extends over the entire cross section of the pilot working chamber 100.

In the closed position, the sliding tappet 102 preferably lies against a first valve seat which is formed in the main piston 76. The sliding tappet 102 of the pilot valve 70 preferably has at least one passage bore, or a plurality of passage bores 112, which extends/extend in the axial direction through the sliding tappet 102 and forms/form a flow duct for hydraulic fluid through the sliding tappet 102. The flow passages 112, and in particular the pilot working chamber 100, are preferably fluidically connected to the first fluid passage 39 and the second fluid passage 40.

The pilot valve 70 preferably has a pilot spring 108 which is disposed in such a manner that it impinges the sliding tappet 102 with an axial force acting in the direction of the armature 62, in particular in the opening direction of the pilot valve 70. The pilot spring 108 preferably serves as a fail-safe device for the event in which the coil is de-energized, and is designed in such a manner that the hydraulic fluid flows out by way of the pilot outflow duct 104a and in particular a fail-safe valve disposed therein. The pilot spring preferably lies against the sliding tappet 102 and the main piston 76. In particular, the pilot spring 108 is designed as a spiral spring and lies against the main piston 76 within the hollow-cylindrical region thereof. By way of example, the pilot spring 102 is supported on an annular step of the sliding tappet 102 that points in the direction of the piston rod-distal working chamber 24.

The sliding tappet 102 preferably has an opening face 110 which is formed on the first region of the sliding tappet that faces the connecting duct 98, and is disposed in such a manner that it closes the connecting duct 98 in the closed position of the pilot valve 70. The opening face 110 is likewise referred to as pilot opening face Aₚ, for example, and preferably has an in particular central clearance that points in the axial direction and is conical, by way of example. The clearance can be designed, for example, so as to be cylindrical, having a round, circular or angular cross section. The clearance preferably serves to enlarge the opening face and thus to set the opening pressure of the pilot valve 70.

The pilot valve 70 preferably comprises a first pilot outflow duct 104a which is designed and disposed for fluidically connecting the pilot working chamber 100 to the first fluid passage 39, preferably to the piston rod-proximal working chamber 22. The first pilot outflow duct 104a is formed by way of example in the housing part 80, in particular in a housing element 106 fixedly connected thereto, and preferably extends from the pilot working chamber 100 into the traction main control chamber 82b. The first pilot outflow duct 104a preferably has a check valve which is disposed in such a manner that a hydraulic flow is enabled from the pilot working chamber 100 into the first fluid passage 39 and is prevented in the opposite direction.

The pilot valve 70 preferably comprises a second pilot outflow duct 104b which is designed and disposed for fluidically connecting the pilot working chamber 100 to the second fluid passage 40, preferably to the piston rod-distal working chamber 24. The second pilot outflow duct 104b is formed by way of example in the main piston 76 and preferably extends axially through the latter, in particular through the first and the second piston region. The second pilot outflow duct 104b preferably extends from the pilot working chamber 100 into the compression main control chamber 82a. The second pilot outflow duct 104b preferably has a check valve which is disposed in such a manner that a hydraulic flow is enabled from the pilot working chamber 100 into the second fluid passage 40 and is prevented in the opposite direction.

During operation of the damping valve device 54, in a movement of the piston rod 20 in the compression direction D, the hydraulic fluid flows through the second fluid passage 40 into the optional comfort valve 28, into the compression main control chamber 82a, whereby the pressure in the compression main control chamber 82a impinges the main piston 76 with an opening force and is moved axially upward. In the process, the main piston 76 is lifted from the main valve seat 90 and the hydraulic fluid flows through the main flow duct 92 to the traction main control chamber 82b, in particular the second fluid passage 39. At the same time, a sub-flow of the hydraulic fluid flows through the first flow passage 86a in the main piston 76 to the pilot control chamber 84 and impinges the main piston 76 with a closing force acting in the direction of the main valve seat 90. The closing force determines the opening width of the main valve 68, in particular the cross section of the main flow duct 92, which determines the damping force of the damping valve device 54. The pressure in the pilot control chamber 84 is set by the pilot valve 70, wherein the hydraulic fluid flows from the pilot control chamber 84 through the connecting duct 98 into the pilot working chamber 100 which is released by the sliding tappet 102. The opening width of the connecting duct 98 is dependent on the axial position of the sliding tappet 102, which is set, in particular predefined, by means of a solenoid 54. In the closed position of the pilot valve 70, the sliding tappet 102 preferably closes the connecting duct 98 completely, so that the hydraulic pressure in the pilot control chamber 84 increases to a maximum value and the main valve 68 is closed and preferably impinged with a force acting in the closing direction, the main piston 76 thereby being pressed onto the main valve seat 90. In an opened position of the pilot valve 70, the connecting duct 98 is at least partially released by the sliding tappet 102, so that a hydraulic flow flows through the passage bores 112 in the sliding tappet 102, and by way of a first pilot outflow duct 104a disposed downstream of the passage bores 112 flows to the traction main control chamber 82b, in particular the second fluid passage 39. A further sub-flow optionally flows through the bypass duct 88 which fluidically connects the compression main control chamber 82a to the traction main control chamber 82b. The fluid flow during a movement of the piston rod 20 in the compression direction D is schematically illustrated by the arrows in FIG. 2, whereby the solid line represents the main flow through the main valve 68 and the dashed line represents the pilot flow through the pilot valve 70 and the bypass flow through the bypass duct 88.

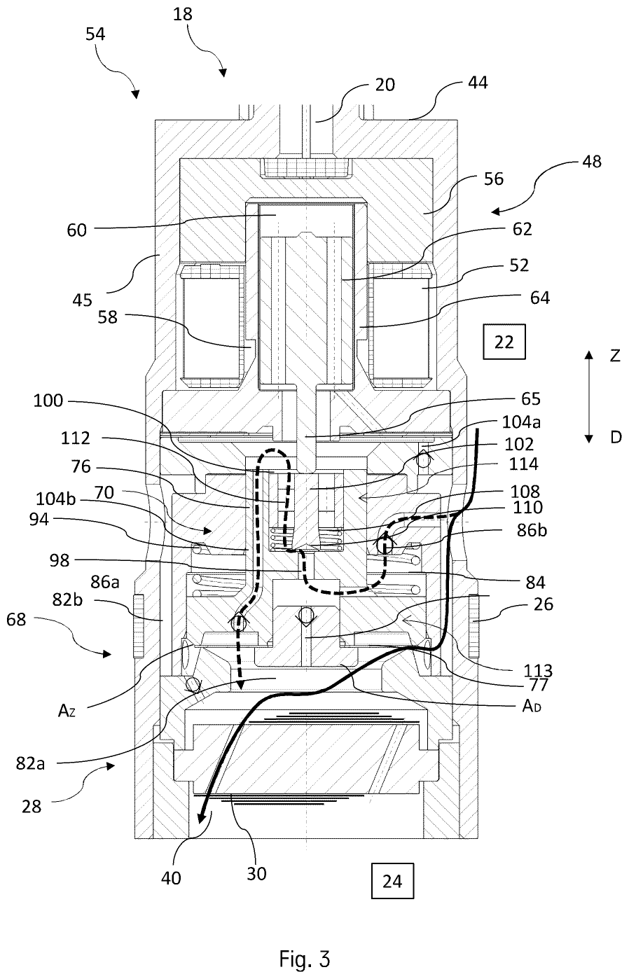

FIG. 3 shows the damping valve device 54 of FIG. 2, wherein the fluid flow during a movement of the piston rod in the traction direction is illustrated. The main piston 76 preferably has a traction opening face A_{Z} and a compression opening face A_{D}. The compression opening face A_{D} is the face of the main piston 76 directly contiguous to the compression main control chamber 82a, wherein the traction opening face A_{Z} is the face of the main piston 76 directly contiguous to the traction main control chamber 82b. The ratio (A_{Z}/A_{D}) between the traction opening face A_{Z} and the compression opening face A_{D} is, for example, 1:1 to 5:1, in particular 2:1 to 4:1, preferably 3:1.

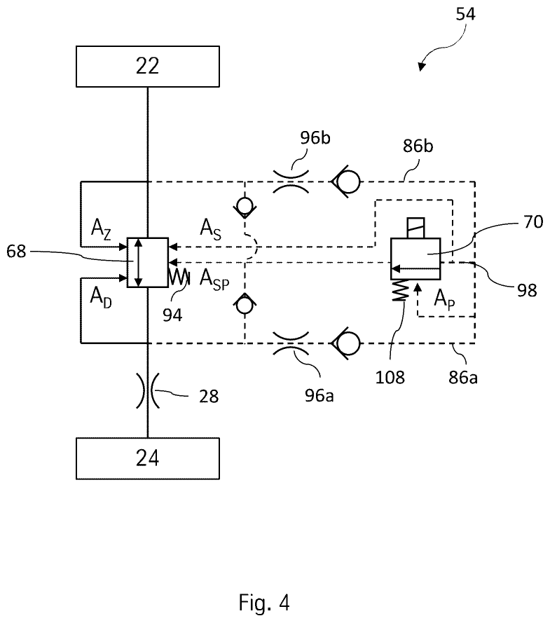

FIG. 4 shows a hydraulic circuit diagram of a damping valve device 54, wherein the solid lines represent the main volume flow and the dashed lines represent the pilot flow. The working chambers 22, 24 of the vibration damper 54 are fluidically connected to one another by way of the main volumetric flow flowing through the main valve 68 of the damping valve device 54. The pilot valve 70 is preferably hydraulically connected in parallel with the main valve 68. In particular, the pilot valve 70 is designed in such a manner that it sets the hydraulic pressure acting on the closing face A_{S} of the main piston 76, in particular as a function of the position of the sliding tappet 102 of the pilot valve 70. The piston rod-distal working chamber 24 is preferably fluidically connected to the pilot valve 70 by way of the first flow passage 86a, for example by way of a flow throttle 96a and a check valve. The piston rod-proximal working chamber 22 is preferably fluidically connected to the pilot valve 70 by way of the second flow passage 86b, for example by way of a flow throttle 96b and a check valve.

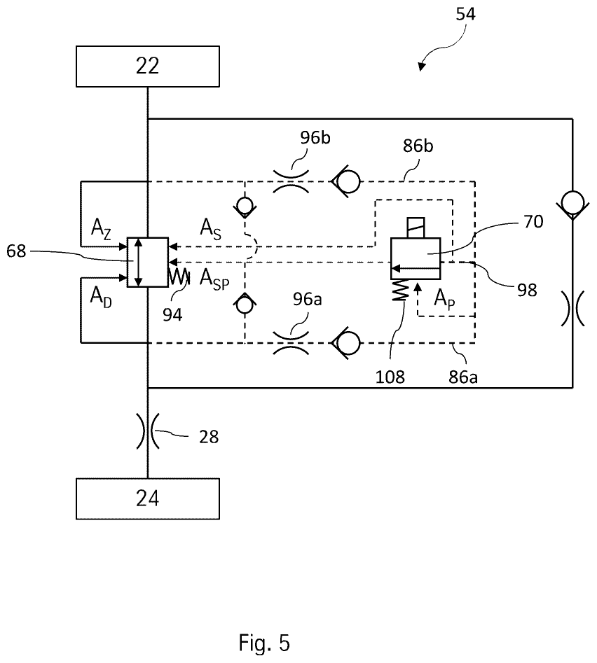

FIG. 5 shows a further example of a hydraulic circuit diagram of a damping valve device 54, which substantially corresponds to that of FIG. 4, wherein a bypass duct 88 is additionally disposed between the piston rod-distal working chamber 24 and the piston rod-proximal working chamber 22. By way of example, a throttle element and a check valve are disposed in the bypass duct 88 so as to be hydraulically connected to one another in series, so that a flow of hydraulic fluid is able to pass through the bypass duct 88 exclusively in one direction, specifically from the piston rod-distal working chamber 24 into the piston rod-proximal working chamber 22. The bypass duct 88 is preferably disposed hydraulically in parallel with the pilot valve 70 and/or the main valve 68.

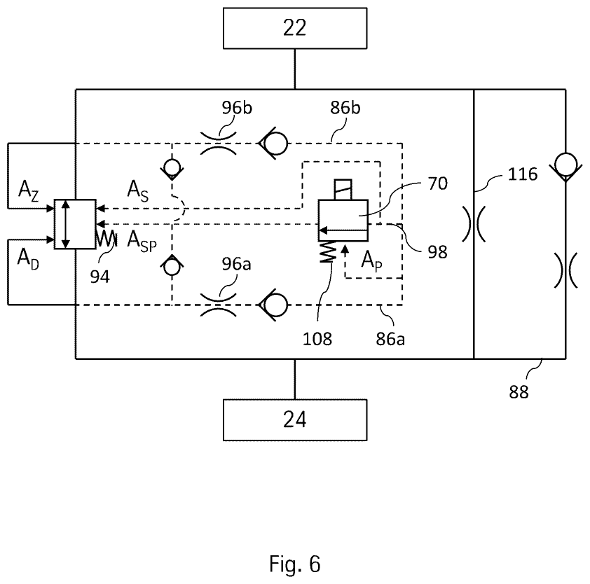

FIG. 6 shows a further example of a hydraulic circuit diagram of a damping valve device 54, which substantially corresponds to that of FIG. 4 or 5, wherein the damping valve device 54 additionally has a further bypass duct 116 which is preferably connected hydraulically in parallel with the bypass duct 88 and in particular has a flow throttle. The further bypass duct 116 is preferably able to be passed through by a flow of hydraulic fluid in the traction phase and the compression phase of the vibration damper 10.

### LIST OF REFERENCE SIGNS

10 Vibration damper
12 Outer tube
14 Inner tube
16 Compensation chamber
18 Working piston
20 Piston rod
22 First/piston rod-proximal working chamber
24 Second/piston rod-distal working chamber
26 Seal
28 Comfort valve
30 Comfort spring disc pack
32 Comfort valve housing
34 Closure pack
36 Base piece
38 Base valve
39 First fluid passage to the first working chamber 22
40 Second fluid passage to the second working chamber 24
42 Spring element
44 Housing upper part
45 Tube part
46 End face/closing face
48 Drive region
50 Valve region
52 Coil
54 Damping valve device
56 Cover portion
58 Magnetic separation
60 Armature space
62 Armature
64 Pole tube
65 Armature rod
68 Main valve
70 Pilot valve
72 Guide element
74 Bypass opening
76 Main piston
77 Spring assembly
78 Main working chamber
80 Housing part
82a,b Traction/compression main control chamber
84 Pilot control chamber
86a,b Flow passage
88 Bypass duct
90 Main valve seat
92 Main flow duct
94 Spring element
96a,b Flow throttle
98 Connecting duct
100 Pilot working chamber
102 Sliding tappet
104a First pilot outflow duct
104b Second pilot outflow duct
106 Housing element
108 Pilot spring
110 Opening face of the sliding tappet
112 Passage bore
113 First piston region
114 Second piston region
116 Further bypass duct
A_{S} First closing face of the main piston 76
A_{D} Compression opening face of the main piston 76
A_{Z} Traction opening face of the main piston 76
A_{SP} Second closing face of the main piston 76

1. A vibration damper of a motor vehicle, comprising:
an outer tube and an inner tube which is disposed so as to be coaxial with the outer tube;
a working piston which is disposed so as to be axially movable within the inner tube and divides the interior of the inner tube into a piston rod-proximal working chamber and a piston rod-distal working chamber; and
a damping valve device which is disposed in the working piston, wherein the damping valve device includes:
a coil;
an axially movable armature which is at least partially disposed within the coil;
a main valve having a main piston which separates a compression main control chamber, a traction main control chamber, and a pilot control chamber from one another;
a pilot valve which is designed in such a manner that it is able to be passed through by a flow of hydraulic fluid in the traction phase and in the compression phase and has a pilot working chamber and a sliding tappet that is disposed in the pilot working chamber and is axially movable by the armature; and
a connecting duct which is disposed between the pilot control chamber and the pilot working chamber and fluidically connects those to one another;
wherein the compression main control chamber by way of a first flow passage, and the traction main control chamber by way of a second flow passage, are fluidically connected to the pilot control chamber.

2. The vibration damper according to claim 1, wherein one flow throttle is in each case disposed in the first flow passage and the second flow passage.

3. The vibration damper according to claim 1, wherein one check valve is in each case disposed on the first flow passage and the second flow passage so that hydraulic fluid is in each case able to flow exclusively in one direction through the first and the second flow passage.

4. The vibration damper according to claim 1, wherein the first flow passage and the second flow passage are disposed separately from one another.

5. The vibration damper according to claim 1, wherein the connecting duct for fluidically connecting the pilot control chamber to the pilot working chamber is formed in the main piston.

6. The vibration damper according to claim 5, wherein the sliding tappet in the closed position of the pilot valve lies against the main piston in such a manner that said sliding tappet fluidically closes the connecting duct.

7. The vibration damper according to claim 1, wherein the pilot valve has a pilot spring which is disposed in such a manner that the latter impinges the sliding tappet with an axial force acting in the direction of the armature.

8. The vibration damper according to claim 1, wherein the damping valve device has a spring element which is attached to the main piston in such a manner that said spring element impinges the main piston with a spring force acting in the closing direction of the main valve.

9. The vibration damper according to claim 1, wherein the main piston has a closing face which is contiguous to the pilot control chamber and is disposed in such a manner that the hydraulic pressure prevalent in the pilot control chamber impinges the closing face of the main piston with an axial force acting in the closing direction of the main valve, and wherein the closing face is formed as a step in the main piston.

10. The vibration damper according to claim 1, wherein the main piston has a traction opening face which is directly contiguous to the traction main control chamber and has a compression opening face which is directly contiguous to the compression main control chamber, and wherein the ratio between the traction opening face and the compression opening face is 1:1 to 5:1.

11. The vibration damper according to claim 1, wherein the main piston has a traction opening face which is directly contiguous to the traction main control chamber and has a compression opening face which is directly contiguous to the compression main control chamber, and wherein the ratio between the traction opening face and the compression opening face is 2:1 to 4:1.

12. The vibration damper according to claim 1, wherein the main piston has a traction opening face which is directly contiguous to the traction main control chamber and has a compression opening face which is directly contiguous to the compression main control chamber, and wherein the ratio between the traction opening face and the compression opening face is 3:1.

13. The vibration damper according to claim 1, wherein the damping valve device has a first pilot outflow duct for fluidically connecting the pilot working chamber to the traction main control chamber, and a second pilot outflow duct for fluidically connecting the pilot working chamber to the compression main control chamber.

14. The vibration damper according to claim 1, wherein the damping valve device comprises a comfort valve which in the compression phase and in the traction phase is able to be passed through by a flow of hydraulic fluid.

15. The vibration damper according to claim 1, wherein the damping valve device comprises a bypass duct which is disposed in such a manner that the latter fluidically connects the compression main control chamber and the traction main control chamber to one another.

16. The vibration damper according to claim 15, wherein a check valve is disposed on the bypass duct in such a manner that the bypass duct is able to be passed through by a flow of hydraulic fluid exclusively in one direction.

17. The vibration damper according to claim 1, wherein the sliding tappet has an opening face which in the closed position of the pilot valve lies at least partially against the main piston, and wherein the opening face has a clearance.
